(19) United States
(12) Patent Application Publication
(10) Pub. No.: US 2025/0319463 A1
(43) Pub. Date: Oct. 16, 2025

(54) Containment Cartridges, Apparatuses, and Methods for Acoustic Levitation

(71) Applicant: Levisonics, Inc., Fishers, IN (US)

(72) Inventors: Nithya Kasireddy, Fishers, IN (US); Manik Dautta, Lawrence, IN (US); Jacob Parmenter, Indianapolis, IN (US); Christine McBeth, Everett, MA (US); Holger Wirz, Medford, MA (US); Jay Chok, Fishers, IN (US)

(73) Assignee: Levisonics, Inc., Fishers, IN (US)

(21) Appl. No.: 19/094,542

(22) Filed: Mar. 28, 2025

Related U.S. Application Data
(60) Provisional application No. 63/572,097, filed on Mar. 29, 2024.

(51) Int. Cl. B01L 3/00

(52) U.S. Cl. CPC B01L 3/502; B01L 2200/025; B01L 2200/026; B01L 2200/0626; B01L 2200/141; B01L 2300/0858; B01L 2300/12; B01L 2400/0436

(57) ABSTRACT

The present invention provides cartridges, apparatuses, and methods for sample containment during acoustic levitation. The cartridges comprise at least one sidewall, which contacts an upper wall to enclose a levitation chamber. A chamber inlet provides access to insert a sample. The lower face of the cartridges can be open or enclosed by a lower film or wall.

### CROSS REFERENCE TO RELATED APPLICATIONS

This application claims the benefit of U.S. Provisional Application No. 63/572,097 filed Mar. 29, 2024.

### GOVERNMENT LICENSE RIGHTS

This invention was made with government support under SBIR Award No. 2134020 awarded by the U.S. National Science Foundation. The government has certain rights in the invention.

### BACKGROUND OF INVENTION

Acoustic levitation has been used to perform noncontact measurements on sample materials. The sample is levitated in a fluid (gaseous or liquid) environment (e.g., air) by high frequency sound waves. Acoustic levitation techniques are particularly useful for measuring the rheological properties of samples, including processes like polymerization, such as the coagulation of whole blood, because they avoid the sample contact with the instrument surfaces, which can otherwise interfere with the inherent viscoelastic behavior of the sample. Noncontact rheological methods and instruments are described in: U.S. patent Ser. No. 11/333,656, U.S. patent Ser. No. 11/815,506, and US Pat. Pub. 2023/0041135.

For acoustic levitation of biological samples, it is desirable to contain potentially biohazardous samples before, during, and after levitation of the sample. It is desirable to protect the operator, laboratory environment, and instrumentation from contamination by the sample. Likewise, it is desirable to protect the sample from environmental and cross-contamination hazards. Although a biological sample is generally contained within an acoustic field during normal operation of the acoustic levitation systems, such containment does not meet the needs for biohazard containment (e.g., it does not separate the sample from the laboratory environment or protect the laboratory environment from potential aerosolized particles) nor does it protect against potential system malfunctions (such as operator error or instrument malfunction, whereby the sample is not contained within the acoustic field).

A containment system for acoustic levitation must not only reduce or prevent biohazard contamination, it must also be compatible with the acoustic field to enable levitation and manipulation of samples for their material property measurements. Certain materials may impede acoustic waves, thus interrupting, interfering with, or preventing acoustic levitation of the sample. Acoustic incompatibility can arise from, among other reasons: the material itself (e.g., polymer or crystalline structure, reflectance properties), from container design (e.g., wall thickness, height or angle), or from operational considerations (e.g., container deflection, depression, or expansion during use).

Accordingly, there is a need to provide materials and methods useful for containment of samples during acoustic levitation.

### BRIEF SUMMARY OF THE INVENTION

In one embodiment, the present invention provides an acoustic levitation cartridge comprising at least one sidewall, each sidewall having an upper edge and a lower edge, wherein at least one sidewall or a portion thereof is optically clear; an upper wall in contact with the upper edge of the sidewall; a levitation chamber enclosed by the sidewall and upper wall; and at least one chamber inlet providing access to the levitation chamber.

In some embodiments, the cartridge has an open lower face. In some embodiments, a cartridge having an open lower face is used with a separate lower film. In some embodiments, a cartridge comprises an attached (affixed or integral) lower wall. In either configuration (both open-faced and closed-faced embodiments), the cartridge can comprise the additional features described.

In one embodiment, the cartridge comprises a single sidewall to define a cylindrical levitation chamber. In preferred embodiments, the single sidewall is entirely optically clear.

In one embodiment, the invention provides a cartridge with an insertion guide, which projects outwardly from a chamber inlet, the insertion guide comprising a channel connecting a distal channel inlet to a proximal channel outlet. The channel is preferably tapered. The insertion guide can be positioned for top deployment (e.g., projecting from the upper wall) or positioned for lateral deployment (e.g., projecting from a sidewall). The insertion guide can provide an angle of deployment from 0° to 90°. In some embodiments, the cartridge includes two or more insertion guides.

In some embodiments, the cartridge comprises a septum that separates the levitation chamber from the external environment. A septum can be placed adjacent to the chamber inlet and/or distally, e.g., at the channel inlet of an insertion guide. A septum can be affixed with a securing ring.

In some embodiments, the sidewall and upper wall are independently composed of polyethersulfone (PES), polystyrene, acrylic, ABS, nylon, acetal, polypropylene, peck PVDF, PETG, or borosilicate glass. In a preferred embodiment, the cartridge is made of polystyrene.

In one embodiment, the lower film is made of acrylic. In some embodiments, the thickness of the lower film is less than 10% of the acoustic wavelength.

In one embodiment, the cartridge or apparatus comprises a separate reflector disposed adjacent to the upper wall.

In one embodiment, the cartridge or apparatus further comprising a securing feature that secures, preferably reversibly secures, the cartridge to the transducer. The securing feature can be located on the cartridge sidewall interior or exterior surface, the cartridge sidewall lower edge, the cartridge lower film, the cartridge lower wall (perimeter or transducer-facing surface), and/or the transducer (perimeter or face). In some embodiments, the securing feature includes complementary mating securing features such as screw threads, tab and groove, or press-fit mechanisms on the cartridge and transducer. In other embodiments, the securing feature can be on only one of the cartridge or transducer.

In another embodiment, the present invention provides apparatuses for enclosed acoustic levitation comprising a cartridge as described, a transducer acoustically coupled to the levitation chamber; and a camera in optical view of the levitation chamber through a viewing window. The apparatus can include a coupling layer to enhance coupling to a lower film. In one embodiment, the apparatus includes one or more injectors, e.g., robotic needles to deploy through the chamber inlet(s).

In another embodiment, the present invention provides a method of acoustic levitation comprising acoustically coupling a cartridge to a transducer; generating an acoustic field from an acoustic generator, whereby the acoustic field is propagated within the levitation chamber via a transducer; inserting a sample into the levitation chamber, to yield a levitated sample; observing the levitated sample through a viewing window.

In one embodiment, the sample is whole blood, blood plasma, biological polymer solution, biological hydrogel clotting blood, or blood clots. Preferably, the sample volume is less than 10 microliters.

### BRIEF DESCRIPTION OF THE DRAWINGS

FIG. 1A shows a perspective view of one embodiment of a machined cartridge according to the present invention. FIG. 1B shows a cross-sectional view of a machined cartridge with tapered insertion channel. FIG. 1C shows a photograph of a milled cartridge manufactured from optically clear materials and featuring an open lower face.

FIG. 2A shows a perspective view of one embodiment of an injection molded cartridge according to the present invention. FIG. 2B shows a cross-sectional view of an injection molded cartridge with tapered insertion channel. FIG. 2C shows a photograph of an injection molded cartridge manufactured from optically clear materials and featuring an open lower face. FIG. 2D shows a photograph of an injection molded cartridge manufactured from optically clear materials and featuring a lower film.

FIG. 3A shows an exploded assembly view of a cartridge including a securing ring, septum, insertion guide, upper wall, sidewall, and lower film. FIG. 3B shows an exploded assembly view including an undeployed injector with needle. FIG. 3C shows a sectional view including an injector with needle deployed through the channel inlet to the interior of the levitation chamber.

FIG. 4A shows a cross-sectional representation of a levitated sample within a levitation chamber. FIG. 4B shows a photograph of a levitated sample within a levitation chamber.

FIG. 5A-D show the automated transfer of a blood and reagent mixture to cartridge. A. After homing and needle (N) pickup, the needle moves to the Vacutainer (V) position. B. Blood is retrieved from the Vacutainer (V). C. Blood is slowly mixed with the reagent (R). D. Blood-reagent mixture is delivered to the cartridge through the septum (arrow) from a top deployment position.

FIG. 6A shows a cross sectional view of a cartridge featuring two oppositely angled top deployment insertion guides. FIG. 6B shows a cross sectional view of the same cartridge with an injector inserted into each insertion guide in position for sample and reagent deployment.

FIG. 7A-C show a perspective view of a cartridge for pairing with a transducer array comprising four transducers. FIG. 7A shows the position of the cartridge comprising four levitation compartments over four corresponding transducers. FIG. 7B shows samples deployed in each levitation compartment using four separately operated injectors. FIG. 7C shows samples deployed in each levitation compartment using four needles operated by a single injector.

FIG. 8A shows a cross-sectional representation levitation chamber with a single chamber inlet on a sidewall. FIG. 8B shows a cross-sectional representation of lateral deployment.

FIG. 9A shows a cross-sectional representation levitation chamber with two diametrically opposed chamber inlets. FIG. 9B shows a cross-sectional representation of bi-lateral deployment.

FIG. 10A-B show perspective views of exemplary press-fit securing feature between the cartridge and the transducer. FIG. 10A shows a cartridge having an open lower face with a securing feature on the interior lower edge of a transparent cartridge sidewall, which mates with a complementary securing feature on the transducer perimeter. FIG. 10B shows a cartridge having a lower wall where the perimeter of the lower wall engages with the securing feature on the transducer perimeter.

FIG. 11A shows a side view of a cartridge having a lower wall and a securing feature (threaded extension) projecting towards the transducer face. FIG. 11B shows an exploded assembly view of a cartridge including a lower wall and a threaded extension, which mates with a transducer face having both a cartridge recess and a securing recess.

FIG. 12A-C show exemplary cross-sectional views of a cartridge secured to a transducer. FIG. 12A shows the cartridge sidewall disposed within a cartridge recess in the transducer face. FIG. 12B shows a cartridge sidewall disposed flush with the transducer edge. FIG. 12B shows the cartridge sidewall extended beyond the transducer face perimeter.

FIG. 13A-B show perspective views of exemplary screw-fit securing feature between the cartridge and the transducer. FIG. 13A shows a cartridge having an open lower face with a securing feature on the interior lower edge of a transparent cartridge sidewall, which mates with a complementary securing feature on the transducer perimeter. FIG. 13B shows a cartridge having a lower wall where the perimeter of the lower wall engages with the securing feature on the transducer perimeter.

FIG. 14A-B show perspective views of exemplary tab-and-groove securing feature between the cartridge and the transducer. FIG. 14A shows a cartridge having an open lower face with a securing feature on the exterior lower edge of a transparent cartridge sidewall, which mates with a complementary securing feature on the interior surface of a cartridge recess on the transducer. FIG. 14B shows a cartridge having a lower wall where the exterior perimeter of the lower wall engages with the interior surface of a cartridge recess on the transducer.

FIG. 15A-B show perspective views of exemplary adhesive securing feature between the cartridge and the transducer. FIG. 15A shows a cartridge having an open lower face with adhesive applied to the lower edge perimeter of a transparent cartridge sidewall. FIG. 15B shows a cartridge having a lower wall where adhesive is applied to the entire transducer-facing surface of the lower wall.

FIG. 16A-D show embodiments having both curved and planar sidewalls. FIGS. 16A and 16C show bottom views of a cartridge having both curved and planar sidewalls. FIGS. 16B and D show perspective views of the cartridge depicted in FIGS. 16A and 16C, respectively.

A summary of reference numbers and reference items is provided. Different views of same features are indicated by (a). The designation of “first,” “second,” and “third,” is for labeling clarity only and does not require positioning or temporal order.

| Ref. No. | Ref. Item |
|---|---|
| 10 | cartridge |
| 11 | sidewall |
| 12 | curved sidewall |
| 13 | planar sidewall |
| 15 | sidewall upper edge |
| 16 | sidewall lower edge |
| 20 | upper wall |
| 21 | chamber inlet (single or first) |
| 22 | second chamber inlet |
| 25 | reflector |
| 30 | levitation chamber |
| 31 | open lower face |
| 32 | lower film |
| 33 | lower wall |
| α, β | angles of deployment |
| 34 | insertion guide (single or first) |
| 35 | second insertion guide |
| 36 | septum |
| 37 | securing ring |
| 40 | insertion channel |
| 41 | channel inlet |
| 42 | channel outlet |
| 45 | insertion guide distal recess |
| 54 | transducer |
| 60 | injector (single or first) |
| 61 | second injector |
| 64 | needle |
| 70 | securing feature |
| 70a | cartridge securing feature |
| 70b | transducer securing feature |
| 71 | securing recess |
| 72 | cartridge recess |
| 82 | sample |

### DETAILED DESCRIPTION OF THE INVENTION

### I. Definitions

As used herein, the term “acoustic levitation” refers to the suspension of a sample against gravity using sound waves. The sample can be suspended in a gaseous (e.g., air) or liquid (e.g., aqueous) environment. In preferred embodiments, the sample is suspended in a gaseous environment, in vacuum, or in air. The present invention is compatible with “acoustic tweezing” which more specifically refers to manipulating a sample while levitated (e.g., by changing its shape or position, applying pressure, inducing oscillation, or otherwise observing the sample's response to an applied stimulus). See U.S. patent Ser. No. 11/815,506.

The “acoustic waves” used in the present invention are high intensity sound waves, typically at ultrasonic frequencies. The acoustic frequency is at least 10 kHz, preferably 10-50, 20-40, 25-35, or 28-32 KHz. A standing wave is generated between the transducer face and the upper wall, and the sample is levitated at or near a node, between anti-nodes, or between a node and anti-node of a standing wave. The invention can be employed using a single mode, dual mode, or multi-mode acoustic field. By spacing the reflector (or upper wall if no separate reflector is used) from the transducer face at a distance of one-half wavelength (λ/2) of the applied frequency (the wavelength corresponding to the frequency of the applied signal), a single mode (first harmonic) acoustic field is generated within the levitation chamber. By spacing the reflector and the transducer face at a distance of one wavelength (λ), a dual mode (second harmonic) acoustic field is generated. By spacing the reflector and the transducer face at a distance of 1.5 wavelengths (3λ/2), a three mode (third harmonic) acoustic field is generated. Using a multi-modal acoustic field provides more options of levitation height and provides an opportunity for levitating multiple samples vertically, while using a single mode acoustic field gives greater consistency of levitation height for observation line of sight, etc.

The term “sample” refers to the material to be acoustically levitated. In one embodiment, the sample is a “biological sample” derived or extracted from a subject (e.g., a laboratory or clinical subject, a livestock, veterinary, or human subject). A biological sample includes, but is not limited to: whole blood, blood plasma, mucus, sperm, lymph, synovial fluid, cerebrospinal fluid, and soft biological tissue. In one embodiment, the biological sample is whole blood. The sample can also be a “non-biological sample” that is not derived or extracted from a subject. Non-biological samples include sample formulations designed to mimic or model biological fluids. Exemplary non-biological samples include, but are not limited to: a polymer, a polymer gel, and a polymeric liquid. The sample may be combined with a reagent before or during levitation.

The term “sample volume” as used herein means the volume of the sample levitated in the acoustic field, including any admixed reagent if applicable. The levitated sample volume can be the same as or smaller than the volume of sample collected from a sample reservoir. That is, complete sample ejection from an injector is not required. In one embodiment, the sample volume is less than: 20, 15, 12, 10, 8, or 5 microliters (uL). In one embodiment, the sample volume is 3-12, 3-10, 5-10, or 5-8 microliters (uL).

When the sample is acoustically levitated, the system allows for photo-optical and/or mechanical tests in a noncontact environment. For example, the system can measure the polymerization of a sample, such as the coagulation of blood. See U.S. patent Ser. No. 11/815,506.

It is desirable for the levitated sample to be visually accessible while still maintaining strict biohazard containment. To this aim, the cartridge of the present invention includes at least one component that is optically clear to allow visual access (e.g., by manual inspection, film or digital camera recordation, etc.). The term “optically clear” means that the material exhibits a visible light transmission sufficient to observe the levitated sample. In one embodiment, the material exhibits a visible light transmission of at least 85, 90, 91, 92, 93, 94, or 95 percent. In one embodiment, the material exhibits a visible light transmission of 90-95%, 90-92%, 92-94%, or 92-95%. In one embodiment, the material exhibits a visible light transmission that meets the standards for clear (un-tinted) spectacle lenses. See, e.g., ASTM Standard Test Methods for Transparency of Plastics.

The term “angle of deployment” as used herein means the angle at which an injector is inserted into the levitation chamber relative to the gravitational vector. Accordingly, a needle inserted parallel to the gravitational vector has an angle of deployment of 0°. In one embodiment, the angle of deployment is 0°-90°, 10°-80°, 20°-70°, 30°-60°, or 40°-50°. In another embodiment, the angle of deployment is 0°-50°, 0°-45°, 5°-45°, 0°-10°, 0°-25°, or 10°-40°. In one embodiment, the angle of deployment is about 45°. In another embodiment, the angle of deployment is about 0°. The angle of deployment can be achieved from any lateral direction of approach (z axis).

### II. Cartridge

In one embodiment, the present invention provides a cartridge for containing sample(s) during acoustic levitation. The cartridge comprises:
a. at least one sidewall, each sidewall having an upper edge and a lower edge, wherein at least one sidewall or a portion thereof is optically clear;
b. an upper wall in contact with the upper edge of the sidewall;
c. a levitation chamber enclosed by the sidewall and upper wall; and
d. at least one chamber inlet providing fluid communication between the interior and exterior of the levitation chamber.
   In some embodiments, the cartridge comprises an open lower face defined by the lower edge of the sidewall(s). In some embodiments, the levitation chamber is enclosed by a lower film in contact with the lower edge of the sidewall(s).

### A. Sidewall

Each sidewall includes an upper edge, a lower edge, an interior surface, and an exterior surface. Each sidewall can independently be curved or planar. The sidewalls can be the same size, or they can be different sizes relative to the circumference or perimeter of the chamber. In one embodiment, the upper edge is at the tail of a gravitational force vector (e.g. it faces “up”), and the lower edge is at the head of the gravitational force vector (e.g., it faces “down”). Similarly, in some embodiments, the upper edge is distal to the transducer, while the lower edge is proximal to the transducer.

In one embodiment, the cartridge comprises a single curved sidewall, such that sidewall forms a cylindrical levitation chamber. A cylindrical sidewall may avoid acoustic disruption that may occur with angular sidewalls. In other embodiments, the cartridge can comprise 3, 4, or a plurality of sidewalls. In one embodiment, the cartridge comprises 4 planar sidewalls such that the levitation chamber is a cube or rectangular prism. In another embodiment, the cartridge comprises at least one planar sidewall. In yet another embodiment, the cartridge comprises at least one planar sidewall and at least one curved sidewall. In another embodiment, the cartridge comprises at least two curved sidewalls and at least two planar sidewalls. In yet another embodiment, the cartridge comprises a plurality of sidewalls, at least two of which are oppositely disposed planar sidewalls.

At least one sidewall or portion thereof is optically clear. The optically clear sidewall or portion thereof is called the viewing window. During operation with an acoustic levitation apparatus, the viewing window is directed toward the viewer (operator) or camera. In one embodiment, one sidewall is optically clear. In one embodiment, the cartridge comprises a single sidewall that is optically clear. That is, the entire single sidewall is the viewing window. The optically clear cylindrical cartridge can be affixed to and viewed from any angle when employed in the acoustic levitation apparatus. In another embodiment, the viewing window is disposed on a planar sidewall to avoid image distortion that may occur when images are taken through curvature. In yet another embodiment, the viewing window is a planar portion of an otherwise curved sidewall.

At least one sidewall or portion thereof, particularly that opposite the viewing window, can be not optically clear. A tinted translucent, colored, or opaque portion of a sidewall can provide a useful background to contrast to the sample when viewed through the viewing window.

In some embodiments, a lower edge of the sidewall(s) further comprises a supporting foot along all or a portion of a lower edge of the sidewall(s). The supporting foot is a region of increased thickness near the lower face to provide enhanced stability. The supporting foot can be an outward extension of a sidewall and or a lower film that increases the contact surface area between the cartridge and the levitation system (e.g. transducer face or system platform, with or without the use of a gasket).

In some embodiments, the cartridge can comprise one or more interior walls that segment the levitation chamber into multiple levitation compartments. For example, a cartridge can be used with more than one transducer to levitate multiple samples simultaneously.

### B. Upper Wall

The cartridge comprises an upper wall in contact with the upper edge(s) of the sidewall(s). The upper wall and sidewall(s) enclose and define a levitation chamber in which the sample will be acoustically levitated.

The upper wall is affixed to the sidewall(s) in any fashion, as would be readily appreciated by one or ordinary skill in the art. The upper wall can be integral to (manufactured as a single component), fused to (e.g., by heat-bonding, adhesive, or sealant), or reversibly or irreversibly mated to the sidewall(s) (e.g., as interlocking components, as screw-fit or locking components).

In one embodiment, the upper wall itself is acoustically reflective. For example, the upper wall can be manufactured from aluminum, acrylic, or polystyrene, which exhibit desirable reflective properties. As would be understood by one of ordinary skill in the art, both the material and thickness of the upper wall can affect acoustic reflectivity. For example, a thin aluminum layer can act as a suitable reflective upper wall as can a thicker polystyrene one. The thickness and rigidity of the upper wall can also serve to deflect the force of needle injection.

In other embodiments, the cartridge further comprises a reflector as a separate component. The reflector helps maintain the standing wave within the levitation chamber by reflecting the acoustic signal transmitted from the transducer. The reflector can be integral to or affixed to the upper wall. For example, if the upper wall is glass, it is desirable to include an additional reflector. In certain embodiments, the reflector is reversibly or irreversibly affixed to the interior surface of the upper wall. In another embodiment, the reflector is embedded within the upper wall. In theory, the reflector can be placed on an exterior surface of the upper wall as long as the reflective surface faces the levitation chamber and the reflective surface can overcome or complement the reflective properties of the upper wall. In a preferred embodiment, substantially the entire interior surface of the upper wall is reflective (except for the chamber inlet, if present on the upper wall). In another embodiment, at least 50%, 60%, 70%, 80%, 90%, 95%, 98%, 99% of the interior surface of the upper wall is reflective (e.g., includes the reflector).

The thickness of the upper wall and/or sidewall(s) can be uniform throughout the chamber. Alternatively, the thickness of the upper wall can be different from the thickness of the sidewall(s). In some embodiments, the thickness of the chamber walls is variable (e.g., the thickness of the sidewall(s) can increase toward the lower edge). The thickness of the upper wall and sidewall(s) can be independently selected from: 0.25 to 2, 0.25 to 1.1, 0.25 to 1, 0.25 to 0.75, 0.3 to 0.9, 0.4 to 1.1, 0.5 to 1.5, 0.5 to 1, or 0.6 to 0.8 mm. In one embodiment, the thickness of the upper wall and sidewall(s) can be independently selected from less than: 1.1, 1.0, 0.9, 0.8, 0.7, 0.6, 0.5, 0.4, 0.3 mm. In some embodiments, the thickness of the upper wall is greater than the thickness of the lower film.

### C. Levitation Chamber

In the cartridge of the present invention, the sidewall(s) and upper wall enclose and define a levitation chamber in which the sample can be acoustically levitated. The sidewall(s) and upper wall each have an interior surface that faces the interior of the levitation chamber and an exterior surface that faces away from the levitation chamber.

The levitation chamber can comprise a vacuum, ambient air, controlled air (air with specified temperature, pressure, or humidity specifications), or another gaseous carrier. Alternatively, the levitation chamber can comprise a liquid carrier, that is, it can be an aqueous levitation chamber.

The dimensions of the levitation chamber are suitable for a) pairing with the transducer and b) for allowing vertical levitation of the sample.

The widest dimension of the levitation chamber along the axis perpendicular to the gravitational force, e.g., the diameter of a cylindrical chamber, or the diagonal of a square or rectangular lower face) can be: 35-150, 35-100, 40-150, 40-125, 40-100, 40-90, 40-60, 50-100, or 75-125 mm. In one embodiment, the diameter of a cylindrical chamber is 40-90, 50-80, or 60-70 mm.

The height of the levitation chamber (that is, the distance at the position of levitation from the lower face or the interior surface of the lower film to the interior surface of the upper wall) can be 5-50, 5-25, 10-20, 10-15, 5-15, or 5-10 mm. In one embodiment, the chamber height is 11.5-12.5 mm or about 12 mm. The height of the levitation chamber must be greater than the levitation height of the sample, as measured from the lower face to the levitated sample. The height of the levitated sample can, but need not be equidistant from the lower face and upper wall. The chamber height preferably allows additional clearance to permit variable levitation heights and a clear view through the viewing window. The chamber height may also be selected in coordination with the intended frequency of acoustic field. For example, the chamber height can be about 0.5, 1.0, or 1.5 of the wavelength of the applied acoustic field.

In some embodiment, the chamber comprises a permeable filter to permit airflow and prevent pressurization during deployment. In some embodiments, a permeable filter can comprise the entire surface of one or more sidewalls or the upper wall. In other embodiments, a permeable filter can comprise a portion of one or more of the sidewalls or upper wall. Although the use of a permeable filter may increase permeability to biohazards, the filtration is sufficient to contain many potential biohazards.

### D. Chamber Inlet

The cartridge comprises at least one chamber inlet that provides access from the exterior of the levitation chamber to the interior of the levitation chamber to deploy the sample in the acoustic field. A chamber inlet can be located on the upper wall, the sidewall, and/or the seam (intersection or curvature) between the upper wall and sidewall, near the upper edge of the sidewall(s).

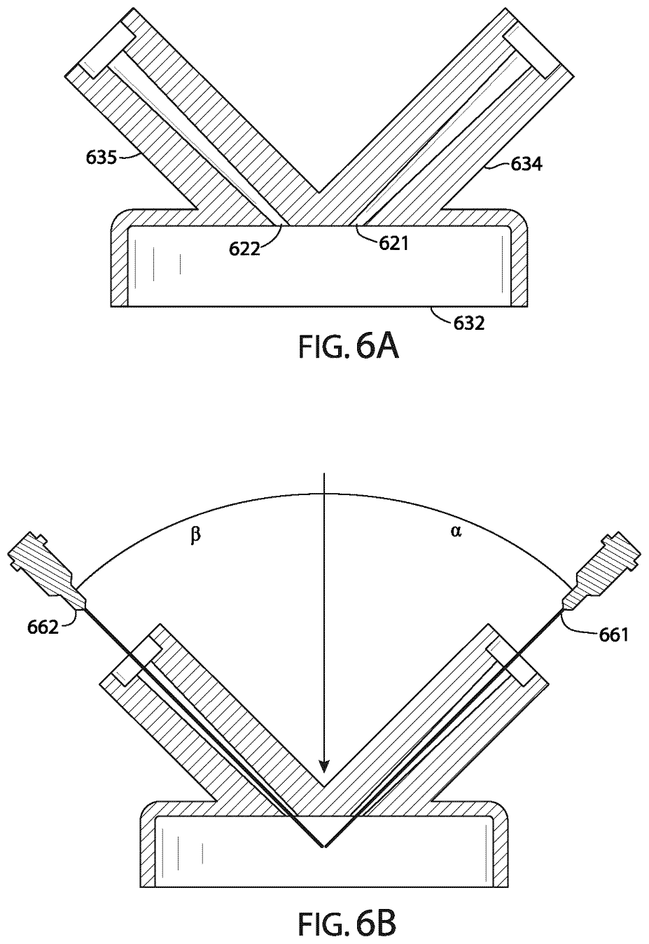

In one embodiment, one or more chamber inlets are located on the upper wall. In one embodiment, a chamber inlet is located in the center of the upper wall. In another embodiment, a chamber inlet is located on the upper wall, but not in its center. A chamber inlet in the upper wall provides for top deployment, in particular an angle of deployment that is parallel (or 0°) to the gravitation vector. In another embodiment of top deployment, the upper wall comprises two chamber inlets. The two chamber inlets can be diametrically opposite one another, or not. In one embodiment, each of two chamber inlets accommodates opposite angles of deployment of about 45° (e.g., about −45° and about 45°, respectively) as shown in FIG. 6B.

In one embodiment, one or more chamber inlets are located on the sidewall(s). A chamber inlet in the sidewall is particularly suitable for lateral deployment, in particular, an angle of deployment that is perpendicular (90°) to the gravitational vector. A chamber inlet can be placed at any height on the sidewall, e.g., above, below, or at the estimated node or levitation height. When a chamber inlet is located on the sidewall(s), the chamber inlet and angle of deployment preferably do not interrupt the sightline through the viewing window.

In one embodiment, the cartridge comprises a single chamber inlet. In another embodiment, the cartridge comprises more than one chamber inlet. In one embodiment, the cartridge comprises at least: 2, 3, 4, 5, or 6 chamber inlets. When the cartridge comprises more than one chamber inlet, the chamber inlets can be arranged in any spacial arrangement, e.g., a line, an array of aligned or offset rows and columns, a square or circle arrangement, spacially equidistant or non-equidistant, etc. When the cartridge comprises more than one chamber inlet, the chamber inlets can also be disposed only on the upper wall, only on the sidewall(s), only on the seam (near upper edge of sidewall(s), or a combination thereof.

In addition to providing access for sample deployment, a chamber inlet can provide access to deliver reagent to a sample within the levitation chamber or to remove a sample from the chamber.

The diameter of a chamber inlet is large enough to accommodate an injector needle. In one embodiment, the needle is a 30 to 22 gauge needle having an outer diameter of 0.312 mm-0.718 mm, respectively. Accordingly, in some embodiments, the chamber inlet is 0.4-10 mm, 0.5-10 mm, 1-10 mm, 1-5 mm, 1-7 mm, or 5-10 mm. The diameter of the chamber inlet can be substantially larger than the needle without sacrificing biohazard containment by including a septum. In some embodiments, a wider chamber inlet diameter is useful to allow compatibility with various needle sizes, to allow compatibility with various angles of deployment, and to allow for acceptable imprecision in needle insertion location.

In some embodiments, the cartridge comprises a septum. The septum is a pierceable layer disposed to separate the levitation chamber interior from the exterior laboratory environment. In one embodiment, the septum is directly affixed to the cartridge on the exterior or interior surface of one or more chamber inlets. There can be a separate septum for each inlet or a septum can span multiple inlets. In one embodiment, a septum is directly affixed to the exterior surface of the upper wall over a chamber inlet. In other embodiments, a septum can be affixed to an insertion guide (described below) at the channel inlet or channel outlet. In yet another embodiment, two septums seal a single injector pathway, for example a septum at the channel inlet and a septum at the channel outlet or chamber inlet. A septum can include a visual or textural marker to denote proper needle insertion location. One of ordinary skill in the art can select any suitable material and manufacturing specifications for the septum by following the guidance recommended for vial containment stoppers, e.g., rubber, silicone, film, foil, or mesh. One of ordinary skill in the art could also select the material taking into account: e.g., biohazard containment upon needle entry and exit, compatibility with needle puncture type (sharp point, beveled, blunted), non-reactive with sample and reagents, avoidance of coring and particulate fragments, etc.

In some embodiments, the cartridge comprises a securing ring that secures a septum to the cartridge. The securing ring can be, for example, a metal or plastic washer. The securing ring can be used in conjunction with or instead of a marker to assist in proper needle insertion position.

The thickness and rigidity of the wall containing the chamber inlet (e.g., upper wall and/or sidewall(s)) is sufficient to distribute the pressure load of needle injection without deflecting the surface and to avoid or minimize disturbance of the acoustic wave. Additionally or alternatively, an injection guide, as described below, can be employed to help distribute the pressure load of needle injection.

### E. Lower Face

The cartridge also comprises a lower face. The lower face is defined by the lower edge(s) of the sidewall(s). The lower face is typically the plane opposite the upper wall. The lower face acts to acoustically pair the levitation chamber to the transducer. In one embodiment, the cartridge comprises an open lower face. In this embodiment, the cartridge acts as a cloche over the transducer and there is no barrier between the transducer face and the levitated sample. The levitation chamber is enclosed by contacting the cartridge with the acoustic levitation apparatus. In one embodiment the lower edge of the sidewall(s) contacts the transducer face directly. In another embodiment, the lower edge of the sidewall(s) contacts a platform provided to surround the transducer face.

Particularly in open lower face embodiments, secure placement with the apparatus can be facilitated by a flexible gasket, such as a silicone or rubber ring (or other shape mirroring or encompassing the perimeter of the lower edges). When the cartridge having an open lower face is placed on the gasket, the contact between the lower edge of the sidewall(s) and the gasket creates airtight containment of the levitation chamber.

In embodiments having an open lower face, the widest interior dimension of the lower face (as measured from the interior surface from sidewall to the interior surface of the opposite sidewall at the lower edge) is preferably slightly larger than the diameter of the transducer face. Embodiments having larger clearances can avoid unintended physical contact between the cartridge and the transducer while also allowing for enhanced compatibility with various transducer sizes. In one embodiment, the widest interior dimension of the lower face is larger than the width of the transducer face by at least 2, 5, 10, 25, 30, 50, or 100. In one embodiment, the transducer face has a diameter of 50 mm, and the cartridge chamber has an interior diameter of 55 mm.

In a cloche configuration, biohazard containment is successfully achieved except that portions of the apparatus, notably the transducer face, may be exposed to the sample. During a normal mode of operation where a sample is introduced into an active standing wave, the sample will not contact the transducer face, so contamination is not likely. If and when sample contacts the transducer face, containment of sample from the operator and laboratory environment is still maintained, and the transducer face can be cleaned and sterilized according to routine laboratory practice. However, to avoid sample cross-contamination and/or reduce transducer face sanitization procedures, the lower face of the cartridge can be used with a separate or attached lower film.

### F. Lower Film

In some embodiments, the present invention provides a separate, removeable, affixed, or integral lower film. In one embodiment, the levitation system comprises a separate lower film. In another embodiment, the cartridge comprises an attached or integral lower film (e.g., a lower wall). A lower film can be affixed to, or integral with, the sidewall(s) in the same manner as described above for the upper wall.

In one embodiment, the levitation system comprises a separate lower film that is used in conjunction with a cloche style cartridge having an open lower face, as described above. The lower film is preferably larger than the open lower face. The lower film can, but need not, have the same shape as the lower face (e.g., a square film can be used with a cylindrical levitation chamber). The lower film preferably covers the entirety of the transducer face that is exposed to the levitation chamber. The lower film should achieve continuous planar contact between the lower face of the levitation chamber and the transducer face. The lower film can be used with or without a gasket, securing means, or coupling layer.

In one embodiment, the lower film is thinner than the upper wall. While the upper wall preferably exhibits appropriate thickness and rigidity to deflect needle insertion forces away from the chamber inlet without disrupting the acoustic field and in some embodiments, and to be acoustically reflective or accommodate a reflector, the lower film preferably exhibits a thinner profile to maximize acoustic signal from the transducer to the levitation chamber. In some embodiments, the thickness of the lower film is less than 10, 9, 8, 7, 6, or 5% of the acoustic wavelength. The thickness of the lower film can be, for example, 0.1 to 0.4, 0.15 to 0.35, 0.2 to 0.3, or about 0.25 mm. In another embodiment, the thickness of the lower film is less than 0.5, 0.4, 0.3, 0.2, or 0.1 mm. In some embodiments, the thickness of the lower film is about 0.1 mm.

In one embodiment, the widest dimension of the lower film (e.g., the diameter of a circular film, or the diagonal of a square or rectangular lower film) is 50-60, 55-60, or about 60 mm.

In embodiments where the cartridge comprises a lower film, the levitation chamber can include a predetermined carrier. In one embodiment, the levitation chamber is a vacuum chamber. In another embodiment, the levitation chamber is filled with a gaseous carrier. In one embodiment, the levitation chamber is filled with air having a predetermined relative humidity. Relevant to embodiments using ambient (laboratory) air and those supplied with sealed air chambers, the humidity of the levitation chamber can be at least: 30, 40, 50, 60, 70, 80, or 90%. Or the humidity of the levitation chamber can be 40-50%, 40-60%, or 40-70%.

### III. Insertion Guide

A sample is preferably deployed by injecting the sample via a needle into a standing wave within the levitation chamber. The location of initial engagement between the needle and the cartridge is the needle inlet (e.g., the location of first physical contact between the needle and the cartridge and/or first entry of the needle into a cartridge cavity without physical contact). In some embodiments, the needle inlet is the chamber inlet. In other embodiments, the needle inlet is adjacent to or directly abuts the chamber inlet, such as when a septum and securing ring are affixed to the exterior surface of the upper wall. In yet other embodiments, the needle inlet is spaced apart from the chamber inlet by an insertion guide.

In one embodiment, the needle inlet is spaced apart from the levitation chamber by an insertion guide comprising an insertion channel. The insertion channel comprises a channel inlet and a channel outlet. In preferred embodiments, the channel inlet serves as the needle inlet, and the channel outlet is in directed fluid communication with the chamber inlet. The insertion guide and its channel project outwardly from the levitation chamber at the location a chamber inlet. Preferably, the channel projects outwardly at a guide angle that defines the preferred angle of deployment. Preferably, the channel extends parallel within and centrally to the guide, although the channel can be disposed in an angular direction and/or not in the center of the guide. In some embodiments, the insertion guide comprises more than one insertion channel leading to more than one chamber inlet. In one embodiment, the guide comprises a single channel. In a one embodiment, the guide and a single channel are both cylindrical and are disposed concentrically.

In a preferred embodiment, the guide and its channel preferably project perpendicularly from the upper wall, away from the levitation chamber. In this embodiment, the guide can help deflect insertion forces to avoid depression of the upper wall and to maintain proper acoustic reflection.

The insertion channel can have a constant diameter, or the channel can be tapered, wherein all or a portion of the channel narrows towards the chamber inlet to assist in guiding the needle toward the chamber. The guide can independently feature a constant or variable exterior circumference. In one embodiment, the guide has a constant diameter, while the insertion channel comprises a variable diameter with a tapered portion narrowing towards the chamber inlet.

In one embodiment, the insertion guide comprises a septum separating the levitation chamber form the exterior environment. In one embodiment, the insertion guide comprises a septum anywhere along the length of the insertion channel. In another embodiment, the insertion guide comprises a septum at the needle inlet of the insertion channel, thereby maintaining sterility of the insertion channel as well as the levitation chamber. In any of these configurations, the insertion guide may also include a securing ring paired with the septum as described previously. In one embodiment, a septum is affixed to the distal end of the insertion guide at the needle inlet. Alternatively, the insertion guide assembly can include a distal recess to accommodate a septum and securing ring.

The insertion guide can be attached to the levitation chamber in any fashion, e.g., detachable (e.g., screw or lock-twist mechanism), fused to (scaled, bonded, melted together), or integral (manufactured as one piece) to the levitation chamber.

### IV. Exemplary Cartridges

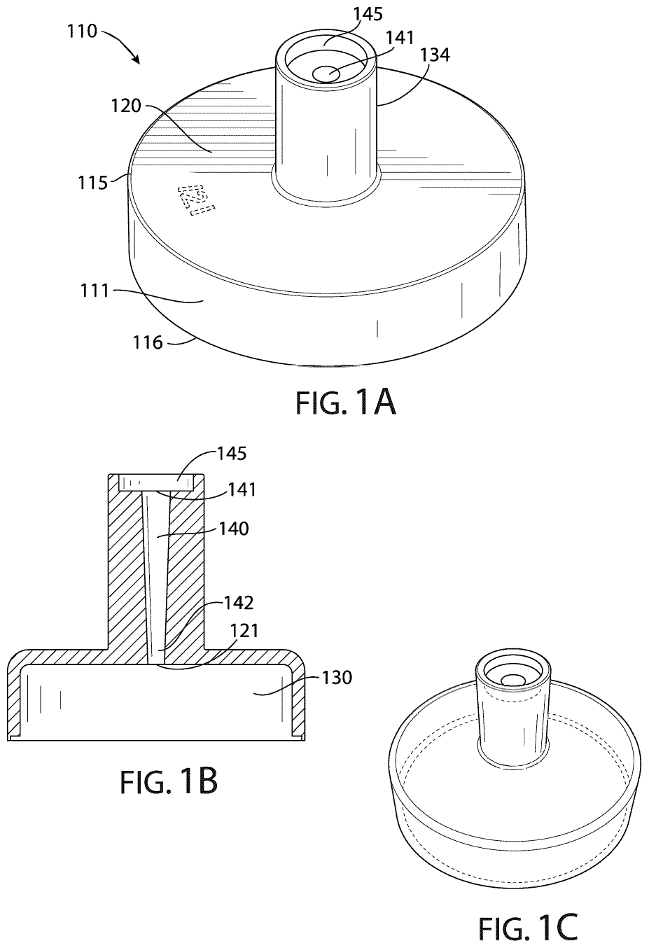

FIG. 1A shows a perspective view of one embodiment of a cartridge according to the present invention. The cartridge 110 comprises a single sidewall 111 having an upper edge 115 and lower edge 116. The sidewall together with the upper wall 120 define a cylindrical levitation chamber. The cartridge also includes an insertion guide with a channel inlet 141 within a distal recess 145. FIG. 1B shows a cross-sectional view of the cartridge showing an insertion channel 140, concentrically disposed in the insertion guide and tapered from channel inlet 141 to channel outlet 142. The channel outlet 142 is in direct fluid communication with chamber inlet 121 to the levitation chamber 130. FIG. 1C shows a photograph of a cartridge manufactured from optically clear materials and featuring an open lower face.

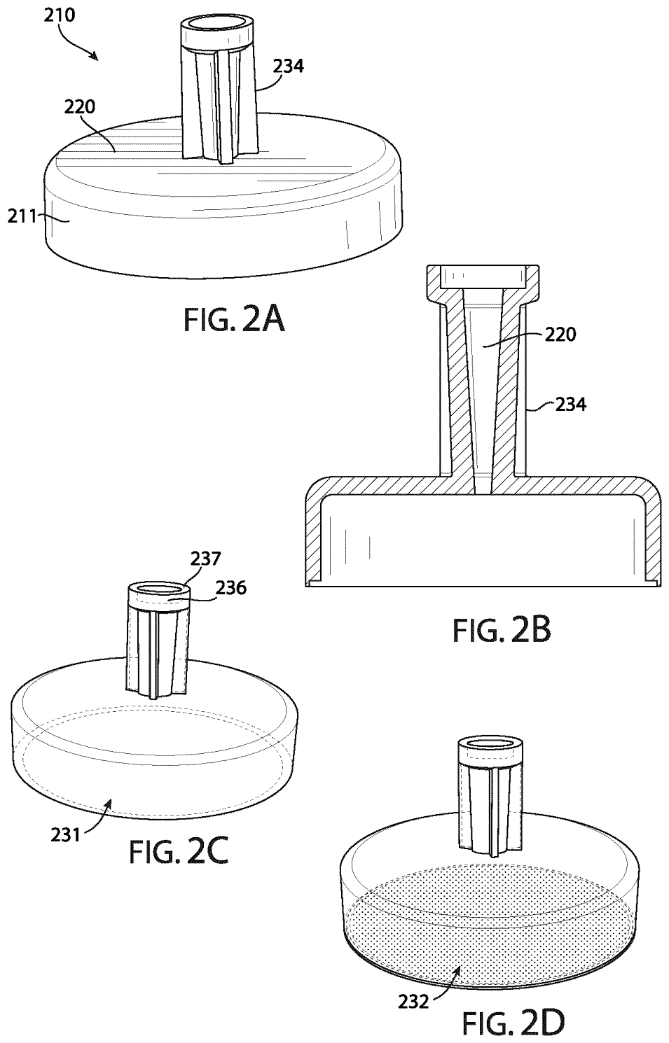

FIG. 2A shows a perspective view of one embodiment of a cartridge according to the present invention. The cylindrical levitation chamber is defined by an upper wall 220 and a single sidewall 211. The insertion guide 234 comprises structural supports rather than a solid cylindrical exterior. FIG. 2B shows a cross-sectional view of the cartridge showing that the insertion guide 234 houses a tapered insertion channel 240. FIGS. 2C and 2D show photographs of an injection molded cartridge comprising an insertion guide 234 with exterior structural supports. FIG. 2C shows a cartridge having an open lower face while FIG. 2D shows a similar cartridge having a lower film. The photographs also show a septum 236 and securing ring 237 placed at the distal end of the insertion guide.

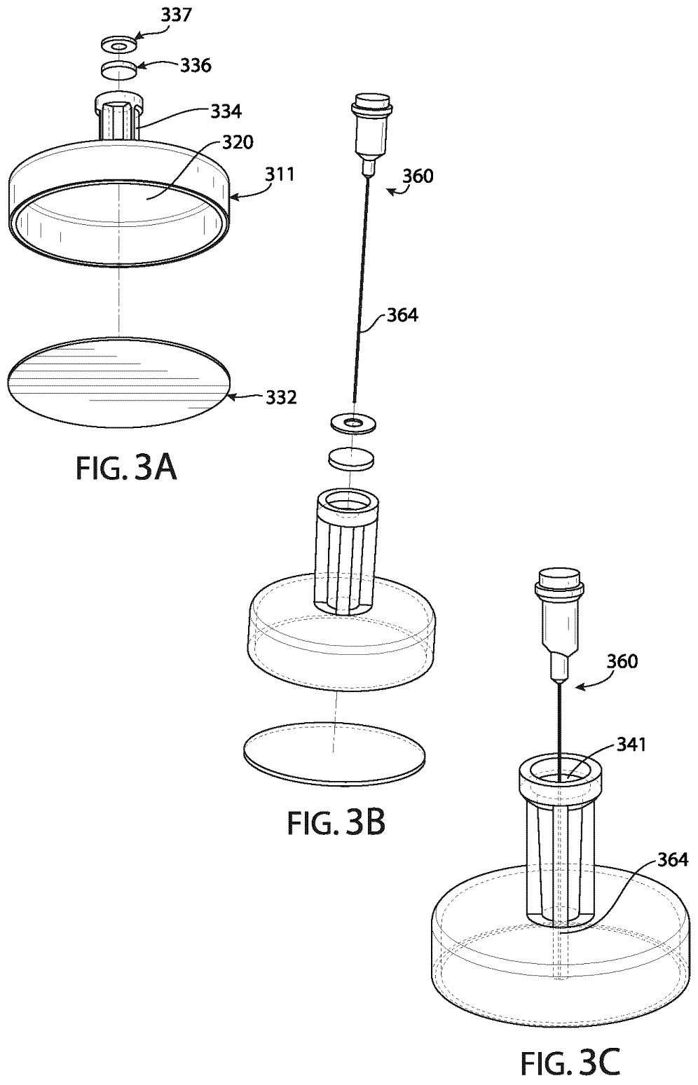

FIG. 3A shows an exploded assembly view of a cartridge including a securing ring 337, septum 336, insertion guide 334, upper wall 320, sidewall 311, and lower film 332. FIG. 3B shows an exploded assembly view including an undeployed injector 360 with needle 364. FIG. 3C shows a sectional view including an injector 360 with needle 364 deployed through the channel inlet 341 to the interior of the levitation chamber.

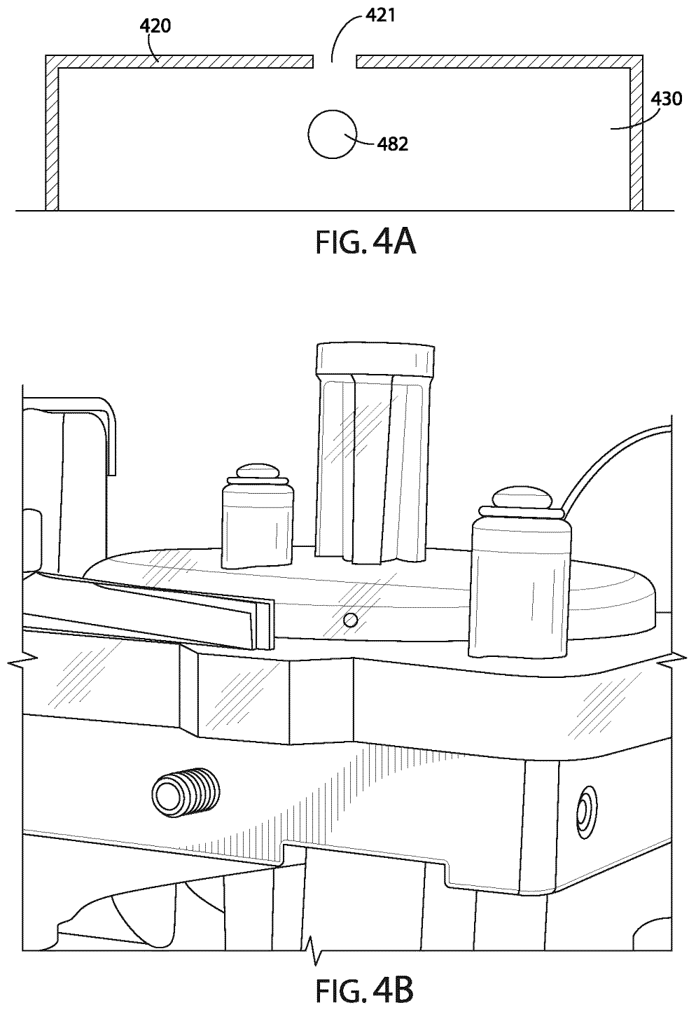

FIG. 4A shows a cross-sectional representation of a levitated sample 482 within a levitation chamber 430. In this embodiment, a single chamber inlet 421 is disposed in the center of upper wall 420. FIG. 4B shows a photograph of a levitated sample within a levitation chamber, where the cartridge is placed over a transducer.

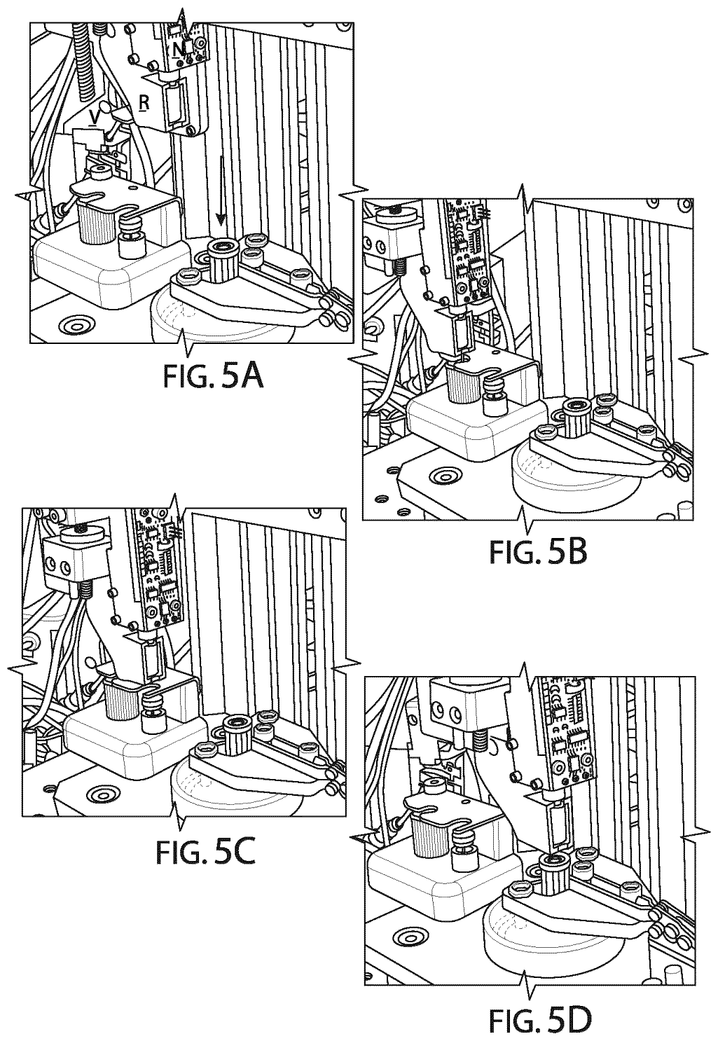

FIG. 5A-D shows a photograph of the cartridge while in place with the levitation apparatus. In particular, FIG. 5A-D show the needle pick-up and deployment positions relative to the cartridge.

FIGS. 6A and 6B show cross sectional views of a cartridge featuring two oppositely angled top deployment insertion guides. A first injection guide 634 guides a first injector 661 through a first chamber inlet 621. A second injection guide 635 guides a second injector 662 through a second chamber inlet 622. The gravitation vector is shown as a downward arrow. FIG. 6B shows a first and second angle of deployment (α, β) defined by the first and second injectors, respectively. The angle of deployment of the first injector In this configuration, the injection guides are arranged to provide a point of contact between the two injector needles to allow for combination of sample and reagent at the intended levitation location.

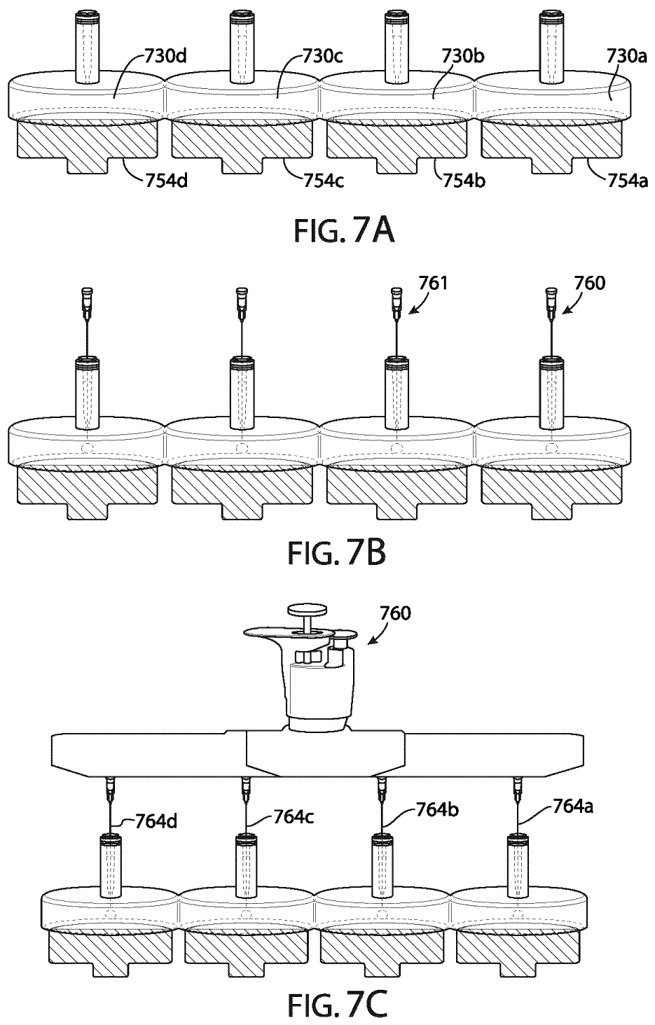

FIG. 7A-C shows a cartridge for deployment of multiple samples. FIG. 7A shows a cartridge wherein the levitation chamber has four levitation compartments 730a-d, each coupled to a respective transducer 754a-d. In this figure they are depicted as adjoining cylindrical compartments without interior barrier walls, but other configurations, such as a continuous rectangular prism, or having one or more interior walls could be employed. The number and arrangement (e.g., non-linear) of the compartments and corresponding transducers can vary. FIG. 7B shows simultaneous deployment of multiple samples using separately operated injectors. FIG. 7C shows simultaneous deployment of multiple samples by multiple needles 764a-d using a single multi-injector 760.

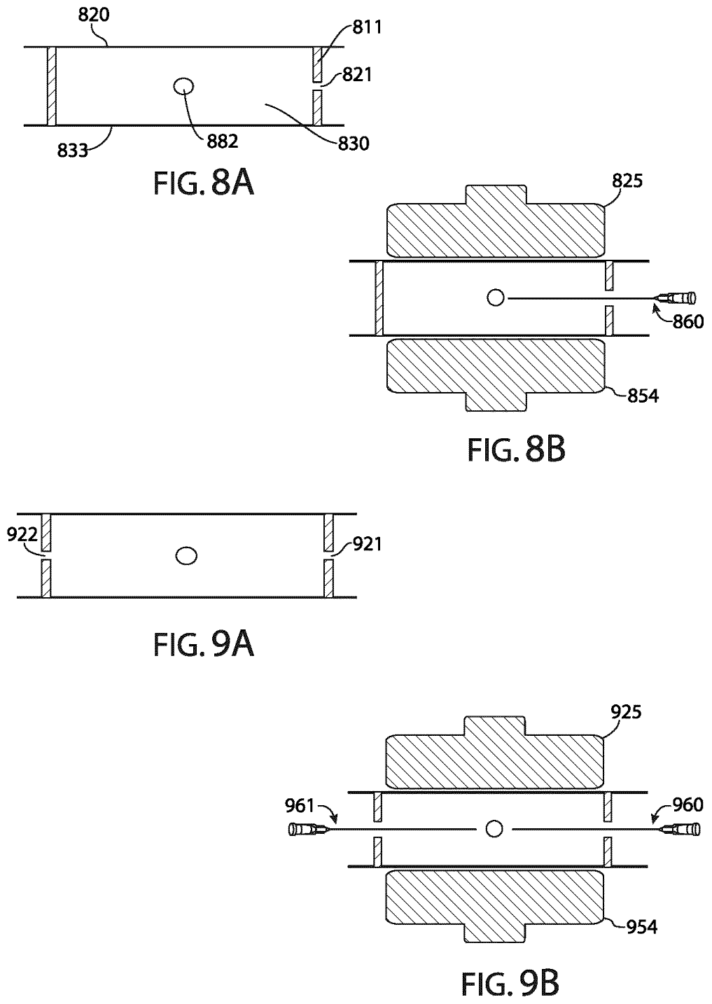

FIG. 8A shows a cross-sectional representation of a levitated sample 882 within a cartridge for lateral deployment. The cartridge comprises an upper wall 820 and lower wall 833, with a single chamber inlet 821 on a sidewall 811. FIG. 8B shows a cross-sectional representation the cartridge in place within a levitation apparatus, where a reflector 825 is disposed adjacent to the upper wall and opposite the transducer face, and the transducer 854 is acoustically coupled to the lower wall. A single injector 860 deploys a sample through the chamber inlet in the sidewall.

FIG. 9A shows a cross-sectional representation of a levitation chamber with two diametrically opposed chamber inlets 921, 922. The two chamber inlets can be placed opposite one another on a single cylindrical sidewall. FIG. 9B shows a cross-sectional representation the cartridge in place between a reflector 925 and transducer 954. Two separately operated injectors 960, 961 deploy a sample and/or reagent through the chamber inlets.

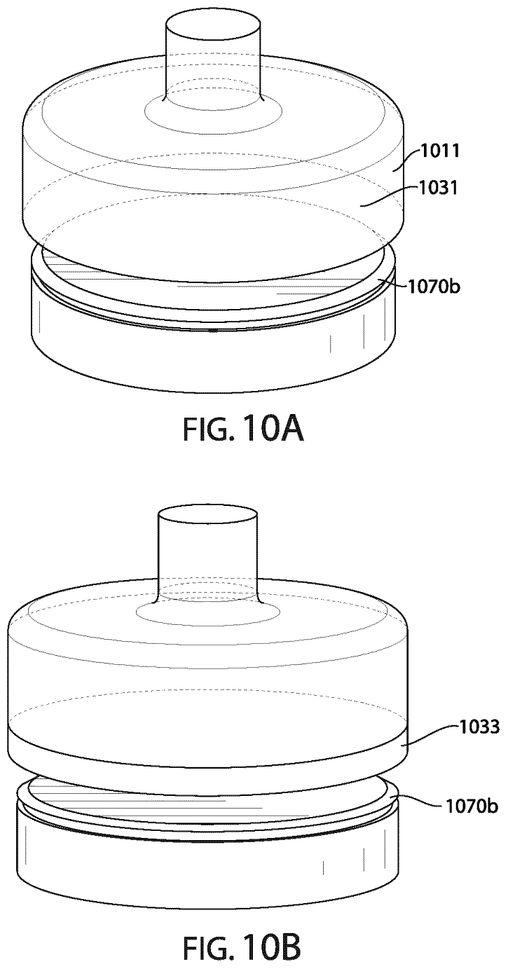

FIGS. 10-15 show exemplary securing means that secure the cartridge to the transducer. FIGS. 10A-B show exemplary press-fit securing features that can be employed with either a cartridge having an open lower face 1031 or a lower wall 1033. The press-fit rim 1070b here is a securing feature on the transducer perimeter. The lower edge of a sidewall 1031 or the interior perimeter of the lower wall 1033 can include a corresponding cartridge securing feature (not shown).

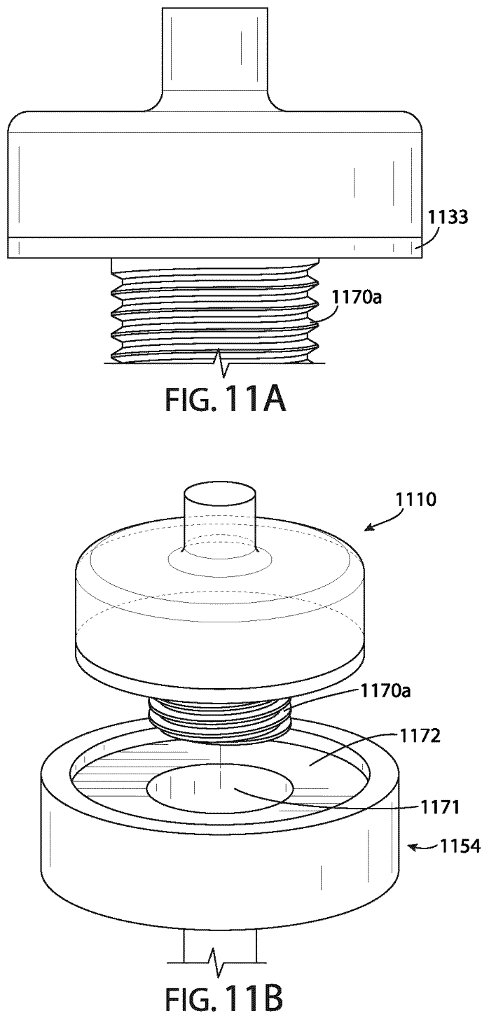

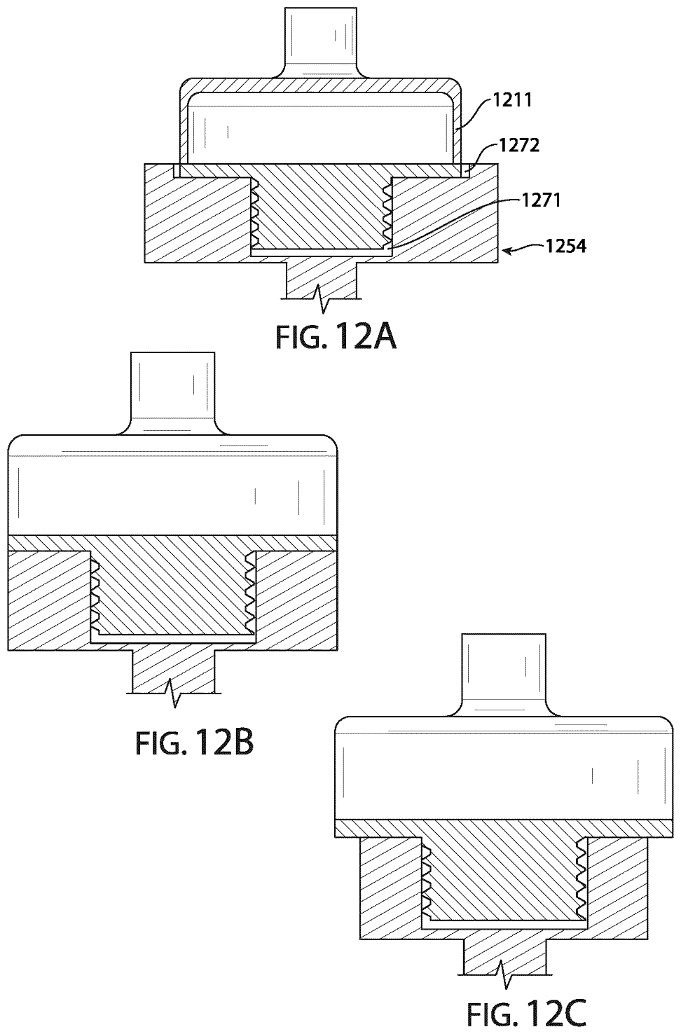

FIGS. 11-12 show exemplary screw thread securing features that can be employed with a cartridge having a lower wall 1133. In these embodiments, the cartridge includes a threaded projection as the cartridge securing feature 1170a. The transducer securing recess 1171 accepts the threaded projection and preferably includes complementary threads on its interior surface (not shown). The transducer 1154, 1254 can also include a cartridge recess 1172, 1272 which can be used additionally or alternatively to the securing recess 1171, 1271 to stabilize the cartridge position relative to the transducer.

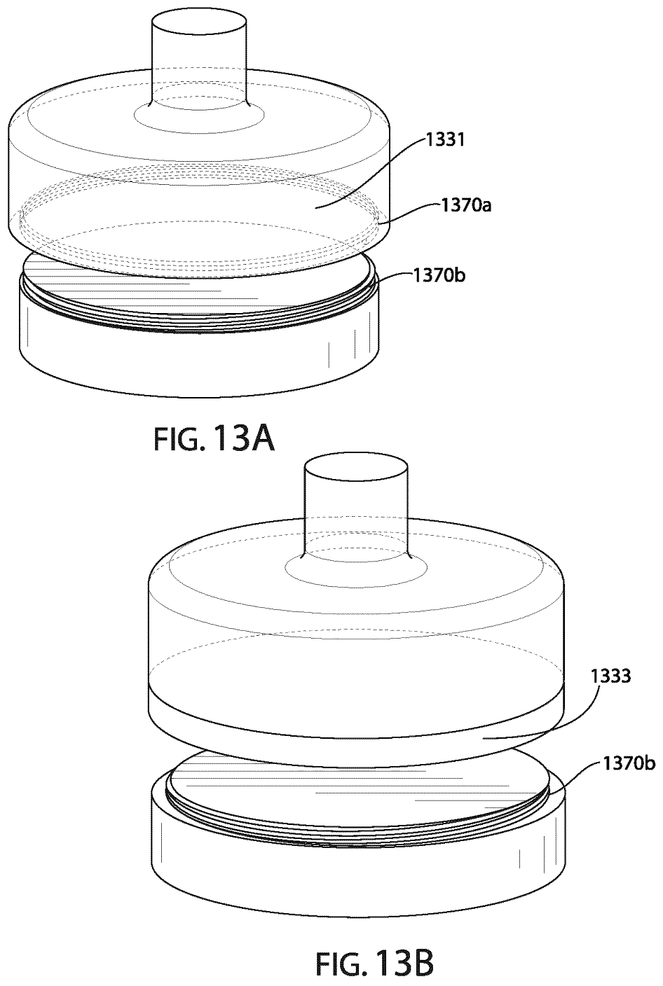

FIGS. 13A-B show exemplary screw thread securing features that can be employed with either a cartridge having an open lower face 1331 or a lower wall 1333. The threaded rim is a transducer securing feature 1370b on the transducer perimeter. In FIG. 13A, the interior perimeter of the sidewall comprises a corresponding cartridge securing feature 1370a. In FIG. 13B, the lower wall 1333 can include a corresponding cartridge securing feature (not shown). While FIG. 13B shows a lower wall 1333 having a circular upper and lower face, as would be readily appreciated by one of ordinary skill, in this and in other embodiments, the lower wall can include different upper and lower faces. The upper face of the lower wall can, for example, match, extend beyond, or complement the sidewall perimeter, while the lower face of the lower wall can independently match, extend beyond, or complement the transducer face.

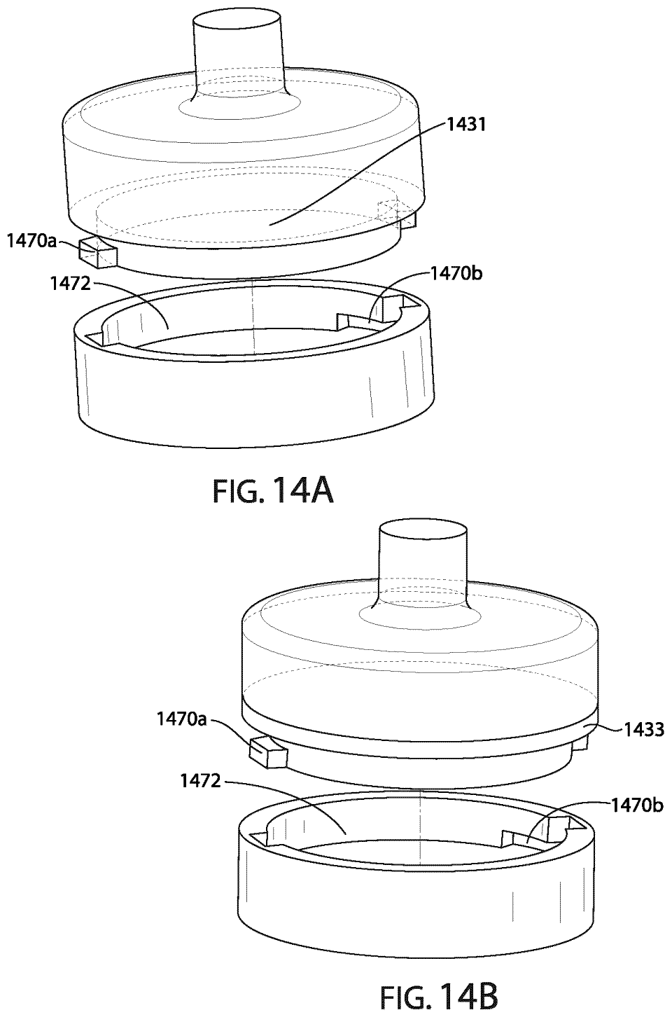

FIGS. 14A-B show exemplary tab-and-groove securing features that can be employed with either a cartridge having an open lower face 1431 or a lower wall 1433. In either configuration the cartridge securing feature 1470a mates with the transducer securing feature 1470b, which is located on the interior surface of cartridge recess 1472. As described with respect to FIG. 13, the securing feature can employ a rotational closure even if the cartridge is not cylindrical by having different upward-facing and lower-facing features.

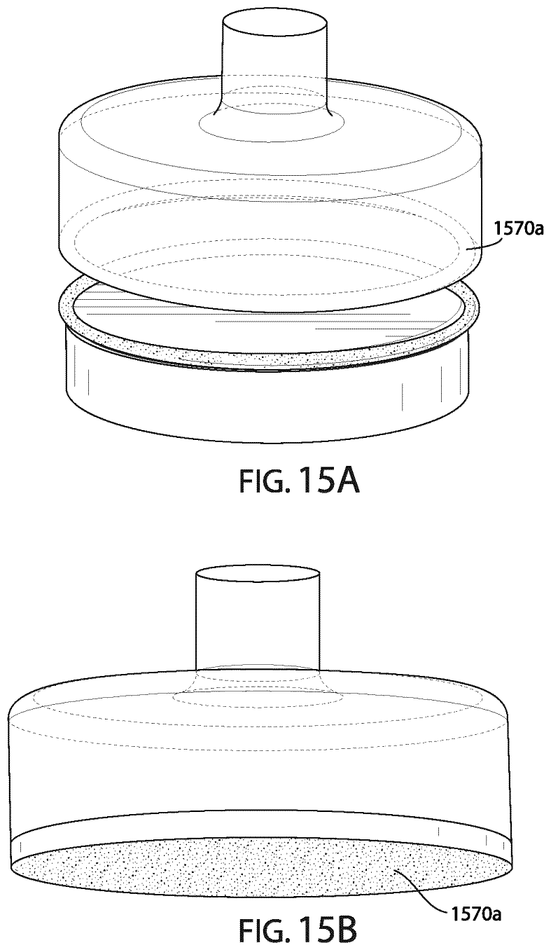

FIG. 15A-B show exemplary adhesive securing features that can be employed with either a cartridge having an open lower face (FIG. 15A) or a lower wall (FIG. 15B). The adhesive cartridge securing feature 1570a is shown applied to the entire sidewall lower edge or the entire cartridge lower wall. The adhesive can alternatively be applied to only a portion of these elements. As would be readily appreciated, the adhesive can be shielded by a protective layer that is peeled off immediately before use. This securing means could employ adhesive on the transducer face in addition to, or instead of, on the cartridge.

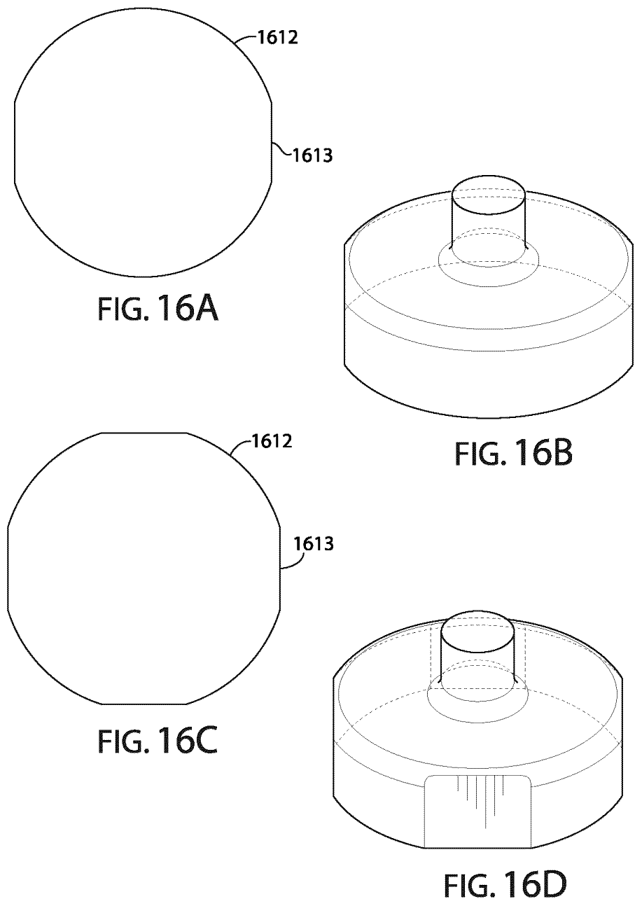

FIG. 16A-D show modified cylindrical cartridge configurations. While maintaining a generally cylindrical shape to enhance acoustic reflection, they include at least one planar sidewall to enhance camera imaging. FIG. 16A-B show a cartridge having two curved sidewalls 1612, and two planar sidewalls 1613. In this embodiment, the planar sidewalls are opposite one another and both are shorter perimeter segments than the curved sidewalls. FIG. 16C-D show a cartridge having four curved sidewalls 1612, and four planar sidewalls 1613. To retain a generally cylindrical shape, it is preferable that the angle where any two sidewalls meet is greater than 90°, 108°, 120°, 135°, 144°, or 150°.

### V. Manufacturing Specifications

Each component can be independently manufactured by any means known in the art including milling, molding, injection molding, extrusion, machining, 3D printing, etc.

The material for each component can be independently selected from any suitable material. The components that comprise the levitation chamber (e.g., the sidewall(s), upper wall, and lower film) must be acoustically compatible. The term “acoustically compatible” as used herein means allowing standing wave(s) to support the levitation of the intended sample. While some disruption of the standing wave can be allowed while permitting levitation, wave disruption should be minimized. Acoustic compatibility can be affected by a material's composition as well as thickness. Acoustically compatible materials include, but are not limited to: polyethersulfone (PES), polystyrene, acrylic, ABS, nylon, acetal, polypropylene, peck PVDF, PETG, or borosilicate glass. In one embodiment, the upper wall and sidewall(s) are polystyrene.

The lower film is acoustically transmissive as well as acoustically compatible. The term “acoustically transmissive” as used herein means that acoustic waves pass through the component. Like acoustic compatibility, acoustic transmittance can also be affected by a material's composition as well as thickness. In one embodiment, the lower film is acrylic.

The viewing window is optically clear as well as acoustically compatible.

The components of the insertion guide can be acoustically compatible, but it is not required as they do not contact the acoustic field.

The cartridge components (e.g., chamber, reflector, lower film, guide, etc.) can be independently disposable and/or sterilizable. In one embodiment, the cartridge is entirely disposable.

In one embodiment, the cartridge as used during normal operation meets or exceeds standards for biosafety level (BSL) 1, 2, 3, or 4 laboratory practices. In a preferred embodiment, the cartridge achieves biohazard containment that meets or exceeds BSL-2 compliance. The levitation chamber is preferably functionally impermeable to aqueous, aerosolized, and/or gaseous contaminants. Although the sample is not intended to contact the sidewall and/or ceiling during normal operation, the cartridge protects the operator and the work environment from dispersal of aerosolized particles during regular operation and/or in case of operation malfunction. The insertion guide assembly may also achieve biosafety compliance as a precaution, but it is not strictly required as the sample will be contained within a delivery needle during its transport into the levitation chamber during normal operation.

### VI. Acoustic Levitation Apparatus

The cartridge is employed in conjunction with an acoustic levitation apparatus. In one embodiment, the present invention provides an apparatus for enclosed acoustic levitation comprising: a cartridge as described above, at least one transducer acoustically coupled to the levitation chamber, an acoustic generator that generates an acoustic field, wherein the transducer acoustically couples the acoustic field to the levitation chamber; and at least one camera in optical view of the levitation chamber through a viewing window.

The engagement between the cartridge and the other components of the apparatus can be enhanced by further including a securing feature. A securing feature secures, preferably reversibly secures, the cartridge in place relative to the transducer. Particularly for cartridge embodiments having an open lower face, the securing feature ensures a tight seal between the cartridge and the transducer to achieve and maintain the sterility of the levitation chamber. For cartridges having either an open or a closed lower face, the securing feature facilitates operability of the device by ensuring a fixed distance between the cartridge upper wall (or reflector) and the transducer face, which is desirable for consistent node formation.

The securing feature can be located on the cartridge sidewall interior or exterior surface, the cartridge sidewall lower edge, the cartridge lower film, the cartridge lower wall (perimeter or transducer-facing surface), and/or the transducer (perimeter or face). In some embodiments, the securing feature includes complementary mating securing features such as screw threads, tab and groove, or press-fit mechanisms, on both the cartridge and transducer.

Exemplary securing features include, but are not limited to, clamps, clasps, straps, screw threads with or without a twist-lock, press-fit, adhesive, or positive (e.g., downward or lateral) or negative (e.g., vacuum) pressure applied to the cartridge and/or apparatus. The securing feature can comprise complementary edge(s) (preferably rounded to facilitate attachment and removal), groove(s), or tab(s). An exemplary press-fit securing feature comprises a rounded edge on the cartridge and the transducer; the operator applies pressure to attach the components over the edge(s) (see, e.g., FIG. 10). A screw-fit securing feature comprises complementary screw threads on both cartridge and transducer; the operator rotates the cartridge (or transducer) to attach. The screw-fit securing feature can be on the perimeter (FIG. 13) or on the face of the components (FIG. 11-12). A twist-lock securing feature comprises complementary screw threads as well as an edge or lip to further secure the components in the closed configuration. An adhesive securing feature can include an adhesive applied to all or part of a cartridge sidewall lower edge (see FIG. 15A), a cartridge lower film, the transducer perimeter, or the transducer face. In one embodiment, the securing feature comprises an adhesive layer disposed on the entire transducer-facing surface (FIG. 15B) of a lower film that is attached to the cartridge. The adhesive is preferably removeable and/or repositionable to allow for cartridge disposal after use.

In one embodiment, the securing feature 70 reversibly secures at least one sidewall, e.g., at a lower edge, to the transducer face or apparatus (FIGS. 10-14). The securing feature can be on the cartridge (70a) and/or on the transducer or apparatus (70b); these features can optionally complementarily mate with one another. In another embodiment, the securing feature reversibly secures at least one sidewall within a cartridge recess in the transducer face. In yet another embodiment, the lower wall of the cartridge has screw threads extending towards and engaging with a securing recess 71 in the transducer face (FIG. 11A-B). The cartridge recess and/or the securing recess can optionally include securing features (e.g., screw threads) on the interior surface to mate with corresponding features of the cartridge. When secured, the cartridge sidewall(s) can be disposed flush with the transducer edge (FIG. 12B). Alternatively, the cartridge sidewall(s) can be disposed within a cartridge recess 72 in the transducer face (FIG. 12A), or the cartridge sidewall(s) can extend beyond the transducer face perimeter (FIG. 12C).

The acoustic levitation apparatus can further comprise a coupling layer. The coupling layer enhances acoustic coupling of the levitation chamber and the transducer face. The coupling layer can be disposed between the lower film and the transducer face. The coupling layer can be, for example, a water-saturated PES membrane or ultrasonic gel. A tight planar contact between the coupling layer and the lower film is desirable to avoid oil-canning or other deformation of the lower film during operation. The coupling layer can, but need not serve as a securing means between the cartridge and the transducer. In other words, the coupling layer can be adhesive or non-adhesive.

The acoustic levitation apparatus can further comprise one or more injectors. The injector can be a robotic needle injector that is automatically inserted through a chamber inlet. Alternatively, the injector can be operated manually. In one embodiment, the injector is a pipette. In both automatic and manual modes of operation, the injector preferably comprises a needle or delivery tip can be detachable from the injector for safe disposal and replacement. In one embodiment, the injector comprises a 30 to 22 gauge needle having an outer diameter of 0.312 to 0.718 mm, respectively. In one embodiment, the needle is 30-22, 30-25, 30-27, 28-22, 26-24, 25-22 gauge. In some embodiments, two or more needles are operated independently by separate injectors (as shown in FIGS. 6B and 7B). Alternatively, two or more needles can be operated by a single multi-injector (as in a multi-pipette dispenser) (as shown in FIG. 7C). A multi-injector is particularly useful for simultaneously deploying more than one sample in a cartridge with more than one levitation compartment over more than one transducer.

In one embodiment, the apparatus comprises two injectors capable of simultaneous deployment through two respective chamber inlets. For example, a first injector can deploy a sample through a first chamber inlet, while a second injector can deliver a reagent through a second chamber inlet, whereby the sample and reagent are combined in the levitation chamber.

The acoustic levitation apparatus can further comprise one or more sample reservoirs to house one or more samples to be delivered to the levitation chamber.

The acoustic levitation apparatus can further comprise one or more reagent reservoirs to house a reagent to be contacted with the sample. Exemplary reagents include, but are not limited to, stabilizers, preservatives, reagents to induce or prevent coagulation, etc.

The acoustic levitation apparatus can further comprise one or more waste reservoirs. After levitation, the sample can be transported from the levitation chamber to a waste reservoir.

### VII. Methods of Use

The present invention also provides a method of acoustic levitation using the acoustic levitation cartridge and apparatus as described above. The method comprises:
a. acoustically coupling a cartridge to at least one transducer,
b. generating an acoustic field from an acoustic generator, whereby the acoustic field is propagated within the levitation chamber via the transducer;
c. inserting a sample into the levitation chamber, to yield a levitated sample; and
d. observing the levitated sample through a viewing window.

In a preferred embodiment, the sample is inserted into an active acoustic field within the levitation chamber. That is, the acoustic field is generated before the sample is inserted. Alternatively, particularly where the cartridge includes a lower film, the sample may be inserted then levitated by subsequent application of an acoustic field.

In one embodiment, the sample is inserted by: collecting a sample in an injector, inserting the injector into the levitation chamber via a chamber inlet, and ejecting the sample from the injector into the levitation chamber. In one embodiment, the injector comprises a syringe pump to collect the sample, but any fluid uptake pump or extractor could be used. In one embodiment, inserting the injector comprises piercing a septum. The needle of an injector can be, but need not be, removed from the levitation chamber during sample observation.

FIG. 5A-D show an exemplary apparatus set-up for the automated transfer of sample (e.g., blood) and reagent before deployment into the cartridge. FIG. 5A shows the robotic needle positions: After homing and needle (N) pickup, the needle moves to the Vacutainer (V) position. Blood is retrieved from the Vacutainer (V). Blood is slowly mixed with the reagent (R). Lastly, the blood-reagent mixture is delivered to the cartridge through the septum in the upper wall (e.g., in a top deployment configuration) (arrow).

The acoustic field can be a single-mode, dual-mode, or multi-mode standing wave. In one embodiment, the acoustic field is a single-mode standing wave.

In one embodiment, the sample is maintained in stable levitation for a duration of: 1 sec to 1 hr, 10 sec to 45 min, 10 sec to 30 min, 1 min to 5 min, 5 min to 20 min. In one embodiment, the duration of stable levitation is at least: 10, 30, 60, 100, or 120 seconds. In one embodiment, the duration of stable levitation is less than: 30, 25, 20, 15, 10, 5, or 1 min.

In one embodiment, the method further comprises a step of manipulating the levitated sample. More specifically, the method can comprise changing the sound waves from an initial acoustic field to a modified acoustic field. This can be accomplished by changing the frequency of the initial acoustic field or by adding one or more additional sound waves to the initial acoustic field. In a preferred embodiment, the camera can record both an initial sample state and a modified sample state.

After levitation of the sample has been observed, the sample can be removed from the acoustic field. Sample removal can be accomplished by collecting the sample from the levitation chamber. For example, the sample can be removed by a sample collector (e.g., an absorbent, capillary, or suction force) via a chamber inlet. Or in another embodiment, especially those using an open lower face cartridge, the sample can be collected by a sample collector (e.g., an absorbent material) by removing the cartridge while maintaining the acoustic levitation field. For embodiments of a disposable cartridge, the cartridge and the sample within can both removed from the acoustic field. In these embodiments, contact of the sample with the cartridge after levitation and before disposal is moot.

The method can further comprise a step of ejecting the needle from the injector. In one embodiment, the needle can be ejected while the needle tip still resides within the cartridge, such that the cartridge, sample, and needle can simultaneously be disposed while protecting the operator from both the sample and the needle. For example, after sample deployment, the injector can be partially withdrawn through the insertion guide, and the needle can be ejected such that the needle tip safely resides within the insertion guide for disposal.

### EXAMPLES

### Example 1: Sample Levitation within an Open Lower Faced Cartridge

The injection molded cartridge as shown in FIG. 2C features an open lower face. The cartridge was placed over a transducer. The distance from the transducer face to upper wall was 6.6 mm to provide a single node system of a 28.260 KHz transducer. A 6 ul sample of blue colored water was deployed through the insertion guide using a needle piercing the septum. FIG. 4B shows the stable levitation of the sample within the levitation chamber.

Although the foregoing invention has been described in some detail by way of illustration and example for purposes of clarity of understanding, one of skill in the art will appreciate that certain changes and modifications may be practiced within the scope of the appended claims. Although particular features may be described herein with respect to certain embodiments, such features may be applied to any embodiment of the present invention. In addition, each reference provided herein is incorporated by reference in its entirety to the same extent as if each reference was individually incorporated by reference.

What is claimed is:

1. An acoustic levitation cartridge comprising:
a. at least one sidewall, each sidewall having an upper edge and a lower edge, wherein at least one sidewall or a portion thereof is optically clear;
b. an upper wall in contact with the upper edge of the sidewall;
c. a levitation chamber enclosed by the sidewall and upper wall;
d. at least one chamber inlet providing access to the levitation chamber from an exterior environment; and
e. an open lower open face defined by the lower edge of the sidewall.

2. The cartridge of claim 1, comprising a single sidewall such that the sidewall and upper wall define a cylindrical levitation chamber.

3. The cartridge of claim 1, comprising at least one curved sidewall and at least one planar sidewall.

4. The cartridge of claim 1, wherein the sidewall and upper wall are independently composed of polyethersulfone (PES), polystyrene, acrylic, ABS, nylon, acetal, polypropylene, peek PVDF, PETG, or borosilicate glass.

5. The cartridge of claim 4, wherein the sidewall and the upper wall are composed of polystyrene.

6. The cartridge of claim 1, further comprising a septum that separates the interior of the levitation chamber from an exterior environment.

7. The cartridge of claim 6, further comprising a securing ring that secures the septum to the cartridge.

8. The cartridge of claim 1, further comprising:
a. at least one insertion guide projecting from a chamber inlet away from the levitation chamber, the insertion guide comprising:
b. a channel providing fluid communication between the exterior environment and the levitation chamber, the channel comprising:
i. a channel inlet distal to the chamber inlet, and
ii. a channel outlet proximal to the chamber inlet.

9. The cartridge of claim 8, wherein the insertion guide projects from the upper wall.

10. The cartridge of claim 9, wherein the insertion guide projects from the upper wall at angle of deployment from 0° to 50°.

11. The cartridge of claim 8, wherein the cartridge comprises two or more insertion guides.

12. The cartridge of claim 8, wherein at least a portion of the channel is tapered to narrow towards the chamber inlet.

13. The cartridge of claim 8, comprising a septum disposed on the channel inlet of the insertion guide.

14. The cartridge of claim 1, further comprising a reflector.

15. The cartridge of claim 1, further comprising at least one securing feature on the lower edge of a sidewall.

16. An acoustic levitation cartridge comprising:
a. at least one sidewall, each sidewall having an upper edge and a lower edge, wherein at least one sidewall or portion thereof is optically clear;
b. an upper wall in contact with the upper edge of the sidewall;
c. a levitation chamber enclosed by the sidewall and upper wall;
d. at least one chamber inlet providing access to the levitation chamber from an exterior environment; and
e. a septum that separates the interior of the levitation chamber from the exterior environment; and
f. a lower film in contact with the lower edge of the sidewall, wherein the lower film acoustically couples the levitation chamber to a transducer.

17. The cartridge of claim 16, wherein the lower film is separable from the levitation chamber.

18. The cartridge of claim 16, wherein the lower film is attached to the levitation chamber.

19. The cartridge of claim 16, comprising a single sidewall such that the sidewall and upper wall define a cylindrical levitation chamber.

20. The cartridge of claim 16, comprising at least one curved sidewall and at least one planar sidewall.

21. The cartridge of claim 16, wherein the thickness of the lower film is less than 10% of the acoustic wavelength.

22. The cartridge of claim 16, wherein the lower film is composed of acrylic.

23. The cartridge of claim 16, further comprising:
a. at least one insertion guide projecting from a chamber inlet away from the levitation chamber, the insertion guide comprising:
b. a channel providing fluid communication between the exterior environment and the levitation chamber, the channel comprising:
i. a channel inlet distal to the chamber inlet, and
ii. a channel outlet proximal to the chamber inlet.

24. The cartridge of claim 23, wherein the insertion guide projects from the upper wall.

25. The cartridge of claim 23, wherein the insertion guide projects from the upper wall at angle of deployment from 0° to 50° degrees.

26. The cartridge of claim 23, wherein the cartridge comprises two or more insertion guides.

27. The cartridge of claim 23, wherein at least a portion of the channel is tapered to narrow towards the chamber inlet.

28. The cartridge of claim 23, further comprising a septum disposed adjacent to the channel inlet of the insertion guide.

29. The cartridge of claim 16, further comprising at least one securing feature to reversibly secure the cartridge to the transducer.

30. An apparatus for enclosed acoustic levitation comprising:
a. the cartridge of claim 1;
b. at least one transducer acoustically coupled to the levitation chamber; and
c. at least one camera in optical view of the levitation chamber through a viewing window.

31. The apparatus of claim 30, further comprising:
a. a lower film disposed between the levitation chamber and the transducer; and
b. a coupling layer disposed between the lower film and the transducer.

32. The apparatus of claim 30, further comprising at least one injector insertable through a chamber inlet into the levitation chamber.

33. The apparatus of claim 30, wherein
a. the cartridge comprises at least two chamber inlets; and
b. the apparatus comprises at least two injectors capable of simultaneous deployment via two chamber inlets.

34. The apparatus of claim 30, further comprising a securing feature on the transducer to reversibly secure the cartridge to the transducer.

35. A method of enclosed acoustic levitation comprising:
a. acoustically coupling the cartridge of claim 1 to a transducer;
b. generating an acoustic field from an acoustic generator, whereby the acoustic field is propagated within the levitation chamber via at least one transducer;
c. inserting a sample into the levitation chamber, to yield a levitated sample;
d. observing the levitated sample through a viewing window.

36. The method of claim 35, wherein the sample is inserted into the levitation chamber through a chamber inlet in the upper wall.

37. The method of claim 35, wherein the sample is whole blood, blood plasma, biological polymer solution, biological hydrogel clotting blood, or blood clots.

38. The method of claim 35, wherein the levitated sample volume is less than 10 microliters.
